(19) United States
(12) Patent Application Publication
(10) Pub. No.: US 2026/0288257 A1
(43) Pub. Date: Sep. 24, 2026

(54) ONE OR MORE NON-TRANSITORY COMPUTER-READABLE STORAGE MEDIA, INFORMATION PROCESSING SYSTEM, AND COMPUTER-IMPLEMENTED METHOD

(71) Applicant: Nintendo Co., Ltd., Kyoto (JP)

(72) Inventor: Hiroki HAMAUE, Kyoto (JP)

(21) Appl. No.: 19/562,329

(22) Filed: Mar. 10, 2026

(30) Foreign Application Priority Data
Mar. 24, 2025 (JP) 2025-048263

(51) Int. Cl. G06F 3/0346; G06F 3/0354; G06F 3/038

(52) U.S. Cl. CPC G06F 3/0346; G06F 3/03544; G06F 3/0383

(57) ABSTRACT

Based on a first condition being satisfied, a shift is made from a first operation mode in which a first object is operated based on mouse sensor data from an input device to a second operation mode in which a second object is operated based on gyro sensor data from the input device, and gyro correction for a direction perpendicular to a gravity direction is performed.

### CROSS REFERENCE TO RELATED APPLICATION

This application claims priority to Japanese Patent Application No. 2025-48263 filed on March 24, 2025, the entire contents of which are incorporated herein by reference.

### FIELD

The present disclosure relates to information processing.

### BACKGROUND AND SUMMARY

Conventionally, an input device may be provided with a gyro sensor. By integrating changes in orientation relative to a reference orientation of the input device using the gyro sensor, the current orientation can be obtained; however, it is known that errors in the measurement values of the gyro sensor accumulate, thereby increasing errors in the orientation of the input device. For example, when a user is playing a game using a game controller including a gyro sensor, the above-described errors may cause the user to feel discomfort due to a lack of correspondence between the actual orientation of the game controller and the processing performed in accordance with the orientation of the game controller. In such a case, the user may perform gyro correction to eliminate the above-described errors, for example, by pressing a specific button.

There has been room for improvement in the usability of gyro correction appropriate for the input device.

For example, the following configuration examples are given.

### Configuration Example 1

A configuration example 1 is directed to one or more non-transitory computer-readable storage media having stored therein instructions that, when executed, cause one or more processors to perform operations including:

in a first operation mode, operating a first object based on mouse sensor data outputted from a mouse sensor of an input device;

in a second operation mode, operating a second object based on gyro sensor data from the input device; and

based on a first condition being satisfied, shifting from the first operation mode to the second operation mode and performing gyro correction for a direction perpendicular to a gravity direction.

### Configuration Example 2

In a configuration example 2 based on the above configuration example 1, the operations further include performing gyro correction in which a direction in which a component perpendicular to the gravity direction, among components included in a direction in which the longitudinal direction of the input device is directed, is directed is regarded as a front direction.

### Configuration Example 3

In a configuration example 3 based on the above configuration example 1 or 2, the operations do not include, in the first operation mode, operating the first object based on the gyro sensor data from the input device.

### Configuration Example 4

In a configuration example 4 based on any of the above configuration examples 1 to 3, the first object and the second object are different objects.

### Configuration Example 5

In a configuration example 5 based on any of the above configuration examples 1 to 4, a light-receiving opening for the mouse sensor is provided in a bottom surface of the input device, and the first condition includes a condition that is satisfied when the light‑receiving opening is not blocked.

### Configuration Example 6

In a configuration example 6 based on any of the above configuration examples 1 to 5, a light-receiving opening for the mouse sensor is provided in a bottom surface of the input device, and the first condition includes a condition that a longitudinal axis of the input device that is parallel to the bottom surface and extends from a near side to a far side when the input device is held by a user is inclined by a specified angle or more with respect to a direction perpendicular to the gravity direction.

### Configuration Example 7

In a configuration example 7 based on the above configuration example 6, the first condition does not include a condition regarding inclination, with respect to a direction perpendicular to the gravity direction, of a short axis of the input device that is parallel to the bottom surface and is perpendicular to the longitudinal axis.

### Configuration Example 8

In a configuration example 8 based on any of the above configuration examples 1 to 7, the operations further include performing gyro correction based on the first condition being satisfied.

### Configuration Example 9

In a configuration example 9 based on any of the above configuration examples 1 to 8, the operations further include controlling the second object based on a movement in a rotational direction around a longitudinal axis directed in a longitudinal direction of the input device.

Each configuration example described above may be read as a configuration example of an information processing system or a computer-implemented method.

### BRIEF DESCRIPTION OF THE DRAWINGS

FIG. 1 is a block diagram showing a non-limiting example of the internal configuration of a game apparatus 10;

FIG. 2 is a schematic diagram showing a non-limiting example of the appearance of a right controller 15 and left controller 16;

FIG. 3 illustrates a non-limiting example of a way of holding the right controller 15;

FIG. 4 illustrates a non-limiting example of a way of holding the right controller 15;

FIG. 5 illustrates a first example according to an exemplary embodiment;

FIG. 6 illustrates the first example according to the exemplary embodiment;

FIG. 7 illustrates a non-limiting example of a case in which gyro correction is not performed in the first example according to the exemplary embodiment;

FIG. 8 illustrates a second example according to the exemplary embodiment;

FIG. 9 illustrates the second example according to the exemplary embodiment;

FIG. 10 illustrates a non-limiting example of a case in which gyro correction is not performed in the second example according to the exemplary embodiment;

FIG. 11 shows a non-limiting example of various data stored in a storage section (memory) 12; and

FIG. 12 shows a non-limiting example of a flowchart of information processing.

### DETAILED DESCRIPTION OF NON-LIMITING EXAMPLE EMBODIMENTS

Hereinafter, an exemplary embodiment will be described.

### Hardware Configuration of Information Processing Apparatus

An information processing system for executing information processing according to the exemplary embodiment will be described. This information processing system is an information processing apparatus such as a game apparatus, a personal computer, a tablet terminal, a smartphone, a wearable terminal, or a server, for example. The information processing system according to the exemplary embodiment may be composed of a plurality of information processing apparatuses, or may be composed of a game apparatus or the like as described above, and a server, for example. In the exemplary embodiment, a game apparatus will be described as an example of the information processing system and the information processing apparatus.

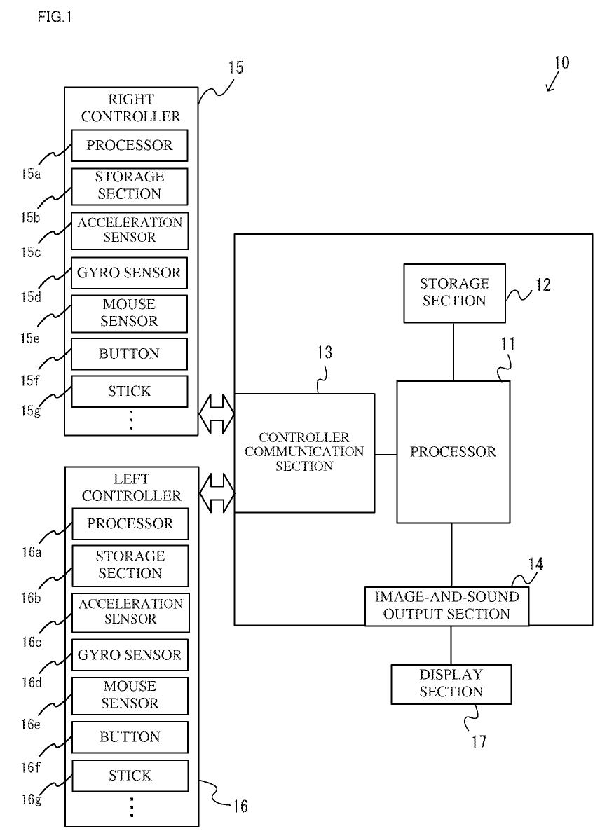

FIG. 1 is a block diagram showing an example of the internal configuration of a game apparatus 10 according to the exemplary embodiment. The game apparatus 10 includes a processor 11. The processor 11 is an information processing section for executing various information processes to be executed on the game apparatus 10. The processor 11 may be composed of a plurality of processors and cores, typically, a plurality of CPUs (Central Processing Units) and cores, or may be composed of a SoC (System-on-a-chip) including a plurality of functions such as a CPU function and a GPU (Graphics Processing Unit) function, for example. The processor 11 executes various information processes by executing an information processing program (e.g., a game program) stored in the storage section 12. The storage section 12 may be an internal storage medium such as a flash memory or a DRAM (Dynamic Random Access Memory), or may be an external storage medium attached to a slot (not shown), or the like. In the exemplary embodiment, the term “processor” may include at least a CPU, a GPU, an ASIC (Application Specific Integrated Circuit), an FPGA (Field Programmable Gate Array), and the like. In the exemplary embodiment, the computer includes at least one processor, as an example, and may further include a storage section such as a memory. In a case where the information processing system includes a plurality of information processing apparatuses, each information processing apparatus may include at least one processor and may include a storage section.

The game apparatus 10 includes a controller communication section 13 for performing at least wireless communication with a right controller 15 and a left controller 16. The controller communication section 13 may control wired communication between the game apparatus 10 and the right controller 15 and the left controller 16 which are input devices. The controller communication section 13 may be included in the processor 11.

A display section 17 (e.g., display) is connected to the game apparatus 10 via an image-and-sound output section 14 in a wired or wireless manner. The processor 11 outputs an image and a sound generated through execution of the information processing, to the display section 17 capable of outputting also a sound, via the image-and-sound output section 14.

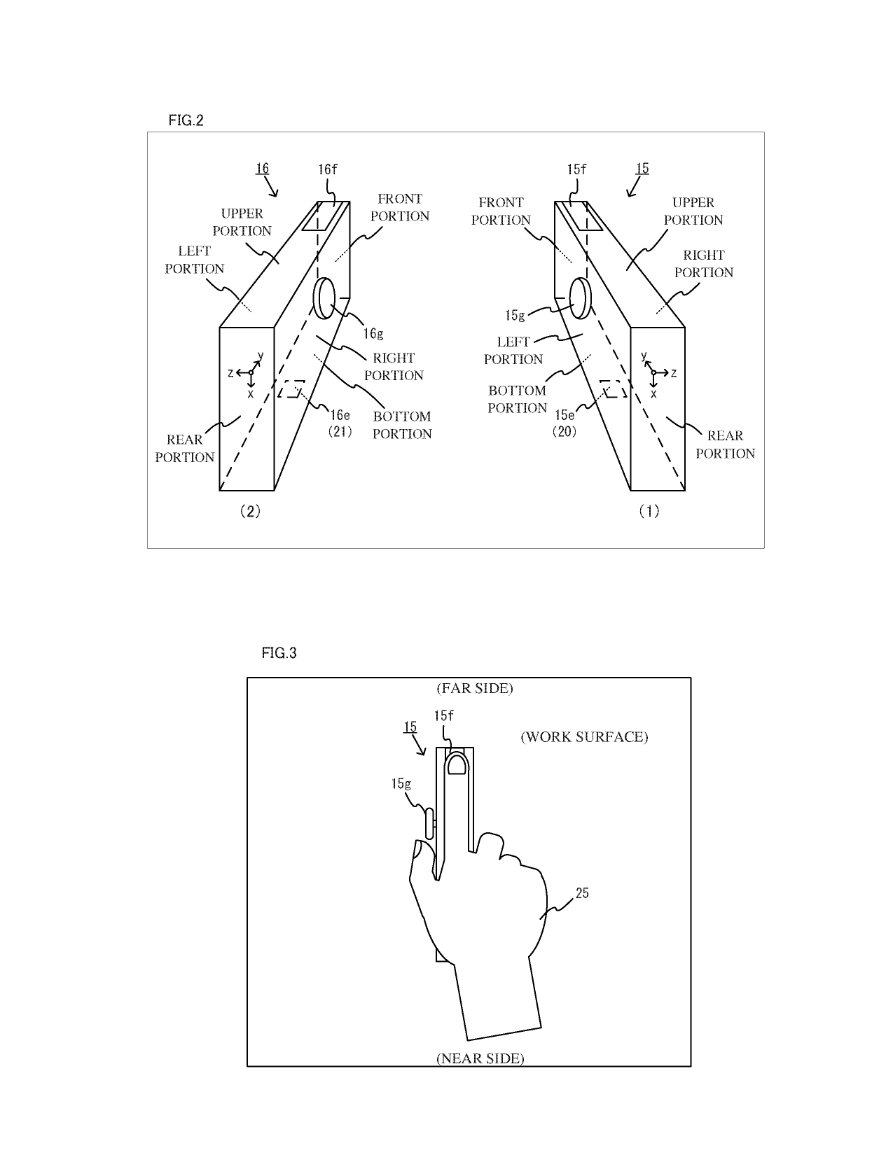

The right controller 15 includes an inertial sensor. Specifically, the right controller 15 includes an acceleration sensor 15c and a gyro sensor (which may be referred to as angular velocity sensor) 15d. The acceleration sensor 15c detects the magnitudes of acceleration along the directions of specified three axes orthogonal to each other (the x-, y-, and z-axes of a right controller coordinate system shown in FIG. 2(1)). The acceleration sensor 15c may, as necessary, detect acceleration along one axis or two axis directions. The gyro sensor 15d detects angular velocities about the specified three axes described above. The gyro sensor 15d may, as necessary, detect angular velocities about one axis or two axes. Detection results obtained by the acceleration sensor 15c and the gyro sensor 15d are repeatedly transmitted to the controller communication section 13 at appropriate timings.

The right controller 15 includes a mouse sensor 15e. As will be described later, the mouse sensor 15e acquires data that allows calculation of movement and the like of the right controller 15 through a mouse operation. The data is repeatedly transmitted to the controller communication section 13 at appropriate timings.

The right controller 15 includes a button 15f and an analog stick 15g. The analog stick (which may be simply referred to as “stick”) 15g can be used as a direction operation section that allows a direction to be inputted. By tilting the stick 15g in any direction, the user can input a direction corresponding to the tilting direction, and can input a magnitude corresponding to the tilting angle. Data indicating operation states of the button 15f and the stick 15g are repeatedly transmitted to the controller communication section 13 at appropriate timings. The direction operation section may be a slide-type stick, a direction key, or a set of four buttons, instead of or in addition to the stick 15g.

The right controller 15 includes a processor 15a and a storage section 15b. The processor 15a can acquire, for example, output data from the acceleration sensor 15c, the gyro sensor 15d, the mouse sensor 15e, the button 15f, and the stick 15g, and can perform various processes by using the acquired data. For example, the processor 15a can determine various operations performed on the right controller 15 by using the acquired data.

The left controller 16 includes a storage section 16b, an acceleration sensor 16c, a gyro sensor 16d, a mouse sensor 16e, a button 16f, and a stick 16g, which have functions similar to those of the processor 15a, the storage section 15b, the acceleration sensor 15c, the gyro sensor 15d, the mouse sensor 15e, button 15f, and the stick 15g included in the right controller 15.

The right controller 15, the left controller 16, and the display section 17 may be considered to be included in the game apparatus 10 or may be considered not to be included in the game apparatus 10.

FIG. 2(1) is a schematic diagram showing an example of the appearance of the right controller 15. As shown in FIG. 2(1), the right controller 15 has, as an example, a plate-like shape having a longitudinal direction along the y-axis (a rectangular parallelepiped or a similar shape in which a thickness in the x-axis direction is smaller than a thickness in the y-axis direction and a thickness in the z-axis direction, and the thickness in the z-axis direction is smaller than the thickness in the y-axis direction) (see the mutually orthogonal xyz coordinate system shown in FIG. 2(1)). The right controller 15 may have another shape. The y-axis may be referred to as longitudinal axis, and the x-axis and the z-axis may be referred to as short axes.

As shown in FIG. 2(1), the right controller 15 has, at a bottom portion thereof, an opening 20 for a mouse sensor (which may also be referred to as “light-receiving opening”). The opening 20 for a mouse sensor is an opening of a light guide path through which light is guided to the mouse sensor 15e disposed inside the opening 20. The mouse sensor 15e is, for example, an optical mouse sensor and may include a light emitting portion and a light receiving portion, for example. Light to be detected by the light receiving portion may be visible light or light having an invisible wavelength. The mouse sensor 15e acquires data that allows calculation of movement and the like of the right controller 15 on a work surface when the right controller 15 is placed with the bottom portion facing the work surface. Thus, the right controller 15 can be used also as a mouse. An operation for use as a mouse may be referred to as “mouse operation”. The mouse sensor may be, for example, a sensor of a type that detects movement of a trackball. The work surface is not limited to a flat surface, and may be a curved surface or the like, e.g., the surface of a thigh of the user.

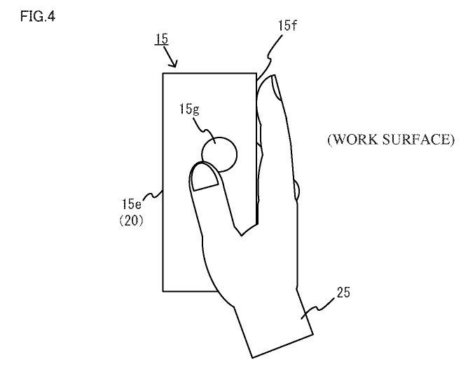

Further, as shown in FIG. 2(1), the right controller 15 includes the button 15f. The button 15f is provided, for example, at an end portion on a front side in an upper portion opposite to the bottom portion. The stick 15g is provided, for example, at a position that allows the user to easily operate the stick 15 with a thumb when the user holds the right controller 15 and performs a mouse operation (see FIG. 3).

As shown in FIG. 2(2), the left controller 16 differs from the right controller 15 in that, for example, a stick (16g) is provided at a right portion thereof. Further, as shown in FIG. 2(2), a mutually orthogonal xyz coordinate system defined for the left controller 16 has a z-axis direction opposite to that of the xyz coordinate system defined for the right controller 15 (see FIG. 2(1)).

The number, shapes, positions, and types of the direction operation sections and buttons included in the right controller 15 and the left controller 16 are not limited. The right controller 15 and the left controller 16 may further include other operation sections operated by the user. Only one of the right controller 15 and the left controller 16 may include an inertial sensor and/or a mouse sensor.

### Example of Holding Manner for Controller

FIG. 3 is a schematic diagram showing an example of a state in which the user holds the controller 15 with a right hand 25 and uses the right controller 15 placed on the work surface as a mouse, that is, a state of performing a mouse operation. FIG. 3 is, as an example, a view seen from above in real space. As shown in FIG. 3, the user can perform a mouse operation of moving the right controller 15 on the work surface, can press the button 15f with the index finger or the middle finger, and can operate the stick 15 with the thumb. The right controller 15 is a controller for a right hand in which the stick 15g is disposed at a position that allows the thumb of the right hand to easily operate the controller. In the following, a case in which the user operates the right controller 15 with the right hand will be mainly described. A case in which the user holds the left controller 16 with the left hand and uses the left controller 16 placed on a work surface as a mouse is similar to the above, and thus the description thereof is omitted.

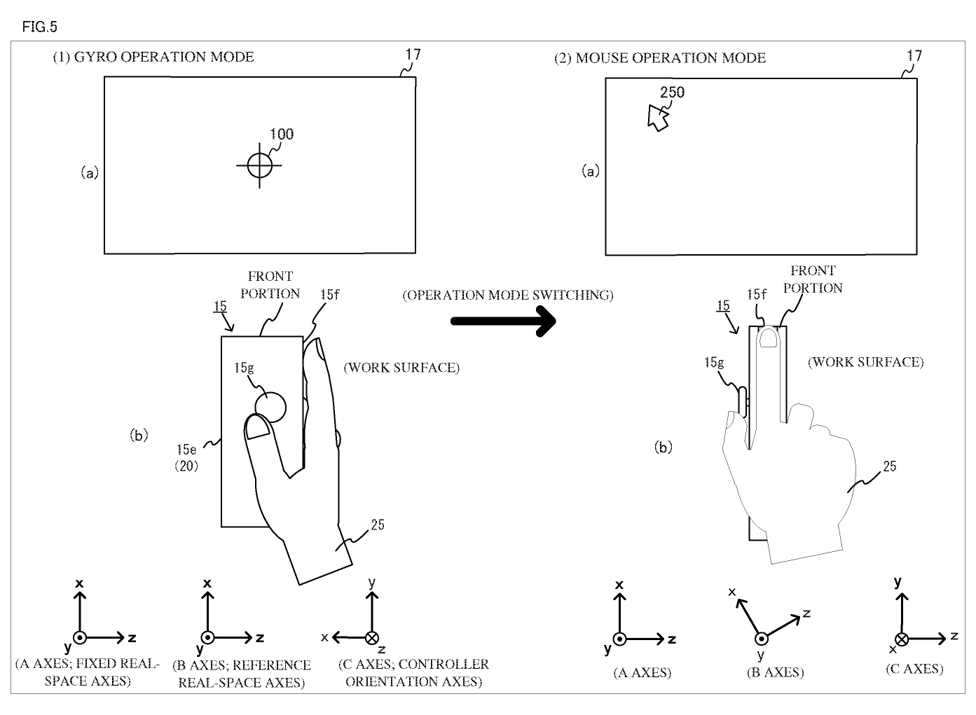

FIG. 4 is a schematic diagram showing an example of a state in which the user holds the right controller 15 with the right hand and operates the right controller 15 in the air. FIG. 4 is, as an example, a view seen from above in real space. As shown in FIG. 4, the right controller 15 can be held and used such that, for example, the longitudinal direction of the right controller 15 corresponds to the up-down direction or the front-back direction for the user. In a case in which the user uses the left controller 16 with the left hand, the user can also use the left controller 16 in the same manner.

Further, the user can, for example, hold the right controller 15 with the right hand in the air as shown in FIG. 4 and perform an operation of changing the orientation of the right controller 15 (which may be referred to as “gyro operation”). Also, in a case of using the left controller 16 with the left hand, the user can perform a gyro operation in the same manner.

### Outline of Information Processing of Exemplary Embodiment

Next, an outline of information processing performed by the game apparatus 10 according to the exemplary embodiment will be described. In the following, the exemplary embodiment will be described by way of a first example and a second example.

### First Example

The first example relates to a game in which a gyro operation mode, in which movement of an aim sight displayed on a screen of the display section 17 (which may be referred to as “screen 17”) is controlled in response to a gyro operation, and a mouse operation mode, in which movement of a mouse cursor displayed on the screen 17 is controlled in response to a mouse operation, are switchable. For example, in the gyro operation mode, bullets are fired toward enemy characters using the aim sight, and in the mouse operation mode, weapons or items are selected using the mouse cursor, and the game is advanced. The same aim sight or cursor may be used in both the gyro operation mode and the mouse operation mode, and the same in-game functions may be provided.

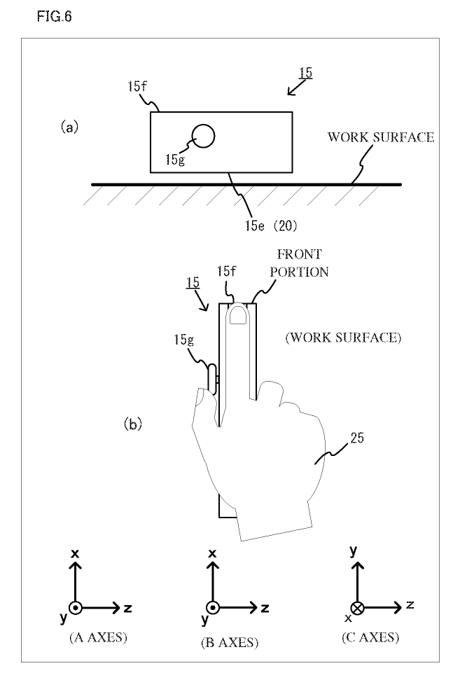

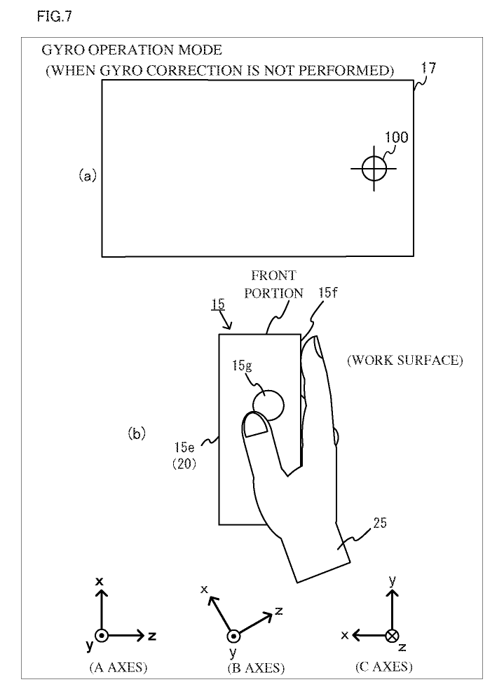

FIGS. 5 and 6 illustrate gyro correction in the first example. FIG. 5(1) shows a scene in which, in the gyro operation mode, the user holds the right controller 15 with the right hand 25 and performs a gyro operation, thereby controlling the position of an aim sight 100 displayed on the screen 17.

In FIG. 5(1), the screen 17 is installed facing the user, and the right controller 15 is held by the user in the air such that a front portion thereof faces the screen 17 (in other words, such that the y-axis positive direction of the right controller 15 (see FIG. 2(1)) is directed toward the screen 17). As an example, in the game according to the exemplary embodiment, when performing a gyro operation, the user is considered to operate the right controller 15 with the front portion thereof facing the screen 17. In FIG. 5(1), the aim sight 100 is positioned at the center of the screen 17 in accordance with the orientation of the right controller 15. In FIG. 5(1), for convenience of illustration, (b) is a view seen from above, and (a) is a view seen in a horizontal direction. The same applies to (a) and (b) of FIG. 5(2) and to (b) of FIG. 6.

As shown in (b) of FIG. 5(1), mutually orthogonal x-, y-, and z-axes defining directions in real space (which may be referred to as “fixed real-space axes” or “A axes”) are considered. The A axes are arbitrary fixed axes in real space, and in the present description, a y-axis positive direction is opposite to the direction of gravitational acceleration (which may be referred to as “gravity direction”), and an x-axis positive direction is a direction toward the screen 17.

The processor 11 sets mutually orthogonal x-, y-, and z-axes serving as reference axes for the orientation of the controller (which may be referred to as “reference real-space axes” or “B axes”) (see (b) of FIG. 5(1)). For the controller or the processor 11, the B axes are considered to be fixed in real space, and rotation of the controller is recognized with reference to the B axes. For convenience of description, in the state shown in FIG. 5(1), the B axes are set to have the same orientation as the A axes. The direction of the y-axis of the B axes is set using a gravity direction measurable by the acceleration sensor 15c. The directions of the x-axis and the z-axis of the B axes are set, for example, by performing gyro correction described later.

Further, the processor 11 calculates the orientation of mutually orthogonal x-, y-, and z-axes fixed to the right controller 15 (which may be referred to as “controller orientation axes” or “C axes”) with respect to the B axes by integrating rotation angles of the right controller 15 using the gyro sensor 15d. If the orientations of the A axes and the B axes coincide, the orientation of the C axes with respect to the B axes indicates the orientation of the right controller 15 in real space.

Since the orientation of the C axes with respect to the B axes is calculated by integrating the rotation angles of the right controller 15 as described above, deviation may occur. That is, when the B axes are considered to be fixed with respect to the A axes, deviation may occur between the orientation of the C axes with respect to the A axes or the B axes and the actual orientation of the right controller 15 with respect to the A axes or the B axes. Alternatively, when the C axes are considered to be fixed to the actual right controller 15, it can be considered that deviation occurs between the orientation of the A axes, that is, fixed axes in real space, and the orientation of the B axes, that is, axes in virtual reality space for the right controller 15. In the present specification, the latter may be referred to as “gyro drift”. By using the acceleration sensor, the gravity direction can be corrected. Therefore, in particular, deviation around the y-axis of the B axes (that is, deviation in the directions of the x-axis and the z-axis) may be referred to as “gyro drift”. In the present specification, “gyro correction” may refer, in particular, to correction for suppressing gyro drift. As an example, “gyro correction” may refer to correction of an orientation around the y-axis of the B axes.

FIG. 5(2) shows a scene in which, in the mouse operation mode shifted from the gyro operation mode shown in FIG. 5(1), the user holds the right controller 15 with the right hand 25 and performs a mouse operation on the work surface, thereby controlling the position of a mouse cursor (which may be simply referred to as “cursor”) 250 displayed on the screen 17. The position of the cursor 250 is controlled based on data that is outputted from the mouse sensor 15e and allows calculation of a movement distance and a movement direction of the right controller 15 in the yz plane. In the exemplary embodiment, in the mouse operation mode, object control based on changes in the orientation of the right controller 15, which is performed in the gyro operation mode, is not performed.

In the gyro operation mode, when it is determined that the right controller 15 is in a state in which a gyro operation is performed, the operation mode shifts to the mouse operation mode. For example, when it is determined that the bottom portion of the right controller 15 is blocked by the work surface or the like and that the longitudinal direction of the right controller 15 (that is, the y-axis direction; see FIG. 2(1)) is substantially horizontal (for example, within a range of ±3°, ±5°, or ±8° from horizontal), it is determined that the right controller 15 is in a state in which a gyro operation is performed, and the operation mode shifts to the mouse operation mode. By setting the conditions for shifting to the mouse operation mode as the above two conditions, it is possible to prevent an unintended shift to the mouse operation mode against the user’s intention, such as when the user unintentionally closes the opening for the mouse sensor with a finger or when the orientation of the controller becomes sideways. The determination that the right controller 15 is in a state in which a gyro operation is performed may be made based only on determination that the bottom portion is blocked, or only on determination that the longitudinal direction is substantially horizontal. Alternatively, conditions for determining that the right controller 15 is in a state in which a gyro operation is performed may be other conditions.

In FIG. 5(2), gyro drift accumulated during operation in the mouse operation mode has occurred in the B axes.

FIG. 6 shows a scene in which the right controller 15 is lifted from the work surface during the mouse operation mode shown in FIG. 5(2). When the right controller 15 is brought into a state in which a gyro operation is performed, the processor 15a sets the operation mode to the gyro operation mode. As an example, when the mouse sensor 15e detects that the bottom portion of the right controller 15 is not blocked by the work surface or the like, the operation mode is set to the gyro operation mode. Conditions for setting the operation mode to the gyro operation mode are not limited, and for example, the orientation of the controller may be used.

When setting the operation mode to the gyro operation mode, the processor 15a performs “gyro correction” for correcting the orientation of the B axes. Specifically, in the exemplary embodiment, as shown in FIG. 6(b), correction is performed such that the x-axis positive direction of the B axes becomes the same direction as the y-axis positive direction of the C axes, more specifically, the direction of a component, perpendicular to the gravity direction, in the y-axis positive direction of the C axes.

In the exemplary embodiment, in the gyro operation mode, it is assumed that the user operates the right controller 15 such that the front portion thereof faces the screen 17. Therefore, by performing correction such that the longitudinal direction of the controller corresponds to the front direction in real space, that is, the x-axis positive direction of the A axes, and the x-axis positive direction of the B axes is also aligned with that direction as described above, gyro correction that causes little discomfort to the user can be performed. In the exemplary embodiment, when gyro correction is performed, that is, when the direction of the component, perpendicular to the gravity direction, in the y-axis positive direction of the C axes coincides with the x-axis positive direction of the B axes, the aim sight 100 is set such that the aim sight 100 is positioned at the center in the left-right direction. Therefore, by performing gyro correction, the user is allowed to operate the aim sight 100 in the left-right direction immediately after switching an operation method from mouse operation to gyro operation.

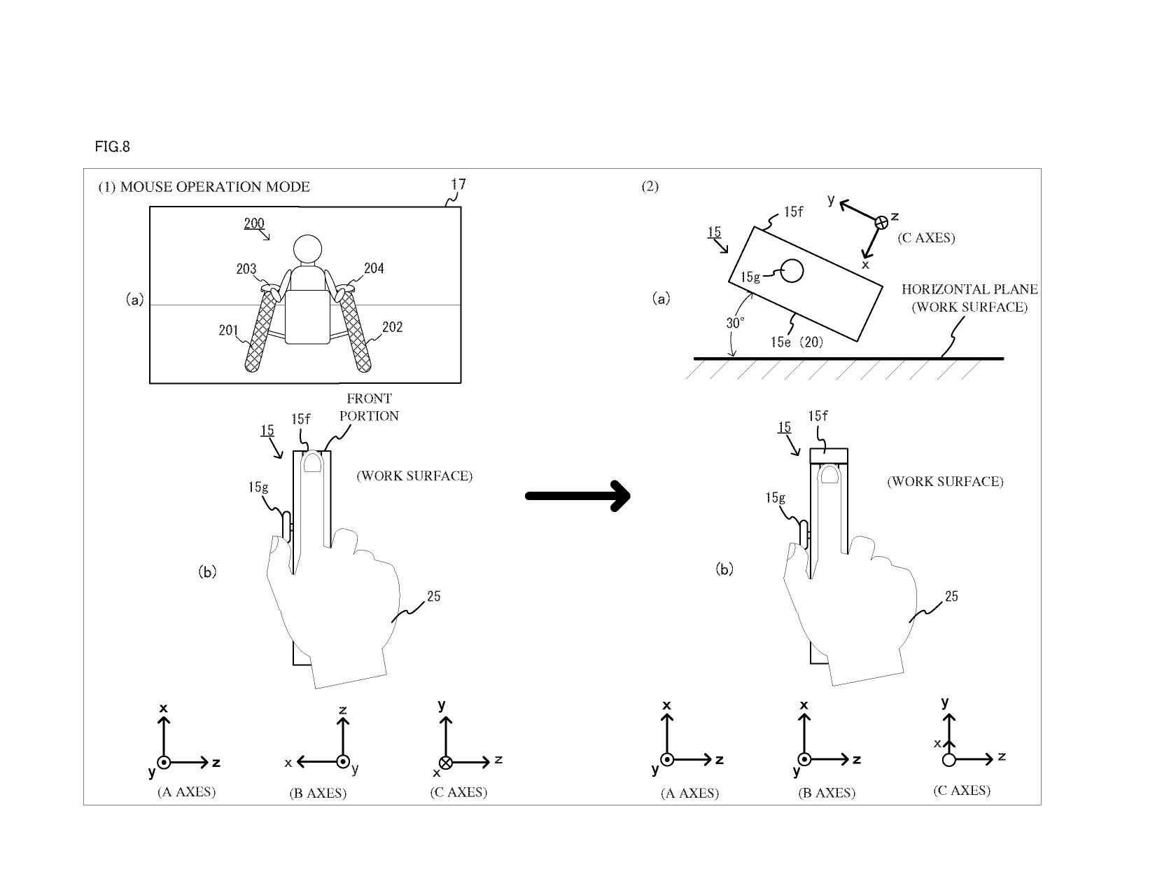

FIG. 7 illustrates a case in which gyro correction is not performed when the operation mode shifts from the mouse operation mode shown in FIG. 5(2) to the gyro operation mode. As shown in FIG. 7, since gyro correction is not performed and a direction around the y-axis of the B axes is not corrected, the processor 11 recognizes that the front portion of the right controller 15 is facing rightward, and as a result, the aim sight 100 is displayed at a position shifted to the right side of the screen 17.

### Second Example

The second example relates to a game in which a character riding a wheelchair is moved or a direction thereof is changed, or the character is caused to wave hands, by operating the right controller 15 and the left controller 16.

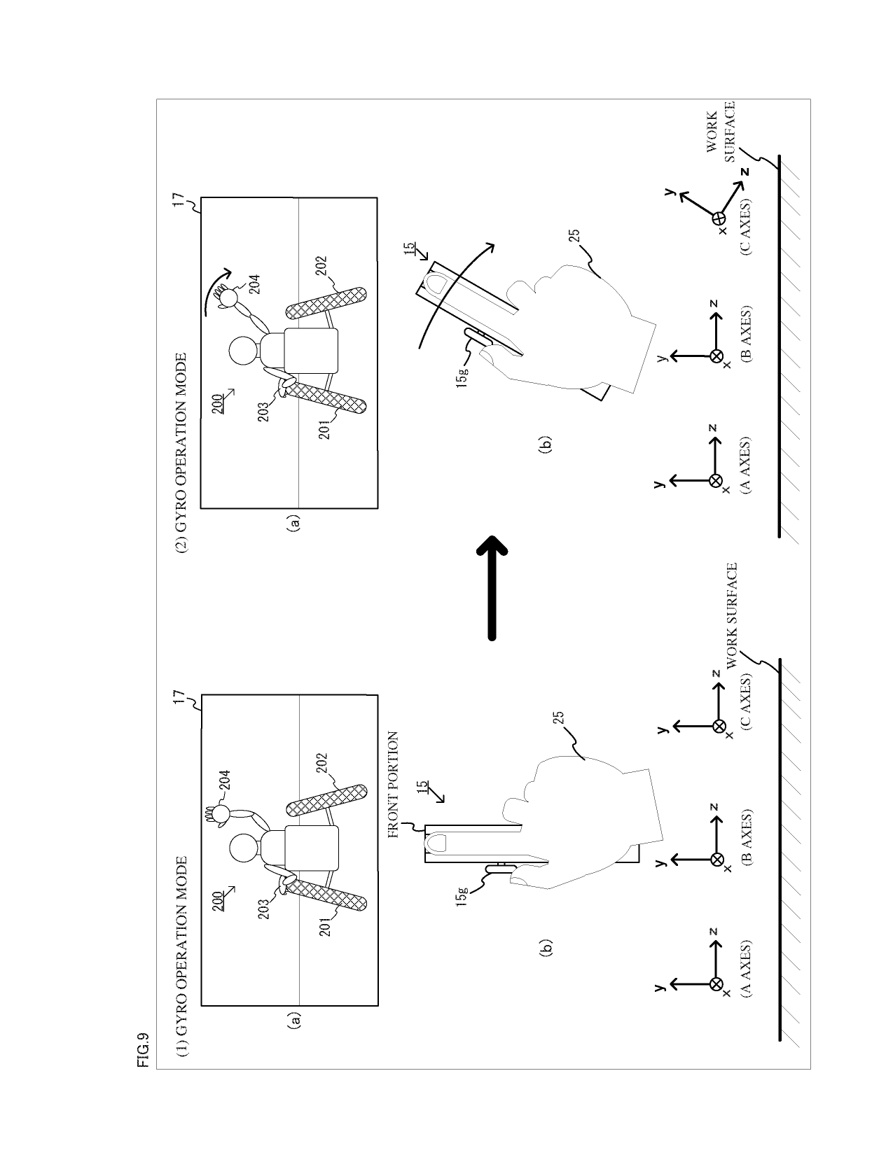

FIGS. 8 and 9 illustrate gyro correction in the second example. FIG. 8(1) shows a scene in which, in the mouse operation mode, an operation for, for example, moving a wheelchair ridden by a character in a field within a virtual space, is performed. In this game, by performing a mouse operation on the right controller 15 to rotate a right wheel 202 of the wheelchair and performing a mouse operation on the left controller 16 to rotate a left wheel 201 of the wheelchair, the user can move the wheelchair or change a direction thereof. In FIG. 8(1), the wheelchair and the character are objects to be operated. As will be described later, a right hand 204 and a left hand 203 of the character may also be objects to be operated.

By moving the right controller 15 on the work surface in the y-axis positive direction in FIG. 2(1), the user can move the right hand 204 to rotate the wheel 202 in a direction in which the right side of the wheelchair moves forward, or by moving the right controller 15 on the work surface in the y-axis negative direction in FIG. 2(1), the user can move the right hand 204 to rotate the wheel 202 in a direction in which the right side of the wheelchair moves backward. Operation of the left wheel 201 is similar. In the following, operation of the right controller 15 will be described, and since the description of operation of the left controller 16 is similar thereto, such description is thus omitted.

In FIG. 8(1), the screen 17 is installed facing the user, and the right controller 15 is placed on the work surface such that the front portion thereof faces the screen 17 (in other words, such that the y-axis positive direction (see FIG. 2(1)) of the right controller 15 is directed toward the screen 17). In the exemplary embodiment, when performing a mouse operation, the user is assumed to operate the right controller 15 such that the front portion thereof faces the screen 17. In FIG. 8(1), for convenience of illustration, (b) is a view seen from above, and (a) is a view seen in the horizontal direction (that is, from the user side). In FIG. 8(2), (b) is a view seen from above.

Definitions of the A axes, the B axes, and the C axes shown in FIGS. 8 and 9 are the same as the definitions of the A axes, the B axes, and the C axes shown in FIG. 5, etc., respectively.

In FIG. 8(1), gyro drift accumulated during operation or the like in the mouse operation mode has occurred in the B axes. Specifically, gyro drift in which the x-axis positive direction of the B axes is deviated by 90° from the y-axis positive direction of the C axes (which may also be said to be the x-axis positive direction of the A axes) has occurred.

FIG. 8(2) shows a scene in which, during the mouse operation mode shown in FIG. 8(1), for example, the right controller 15 is lifted from the work surface, and the y-axis direction of the C axes forms an angle of 30° with a horizontal plane. Since deviation of the B axes in the gravity direction can be corrected by the acceleration sensor, the horizontal plane may be considered as being defined based on either the A axes or the B axes. In FIG. 8(2), the work surface is the horizontal plane. When the processor 11 determines that the y-axis direction of the C axes forms an angle of 30° with the horizontal plane, the processor 11 performs gyro correction. This determination can be made, for example, using the direction of the horizontal plane detected using the acceleration sensor 15c. The processor 11 may also perform gyro correction when the processor 11 determines that the current state is a state where the bottom portion of the right controller 15 is not blocked by the work surface or the like. Gyro correction is performed by aligning the orientation around the y-axis of the B axes with the orientation around the x-axis of the C axes as shown in (b) of FIG. 8(2). More specifically, gyro correction is performed such that the x-axis positive direction of the B axes becomes the same as the direction of a component, perpendicular to the gravity direction, in the y-axis positive direction of the C axes.

FIG. 9(1) shows a scene in which, after gyro correction is performed and the operation mode is switched to the gyro operation mode, the user holds the right controller 15 with the right hand 25 and performs a gyro operation. In FIG. 9(1) and FIG. 9(2), (a) and (b) are both views seen in the horizontal direction.

In the second example, the position and the orientation of the right hand 204 of the character are controlled in accordance with changes in the orientation of the right controller 15 in the gyro operation mode. For example, as shown in (b) of FIG. 9(1), when the right controller 15 is raised such that the front portion of the right controller 15 is directed directly upward, the right hand 204 of the character is raised directly upward.

Further, control is performed such that a direction in which the bottom portion of the right controller 15 faces corresponds to a direction in which the palm of the right hand 204 of the character faces. For example, when the bottom portion faces downward, the palm of the right hand 204 faces downward, and when the bottom portion faces forward, the palm of the right hand 204 faces forward. For example, in response to an operation of rotating the bottom portion around the y-axis of the C axes (which may also be referred to as operation of twisting the right hand of the user), the right hand 204 also moves so as to twist in the same manner. In (b) of FIG. 9(1), since the direction around the y-axis of the B axes has been corrected to a normal direction by gyro correction, the palm of the right hand 204 of the character faces an appropriate direction in accordance with the orientation of the bottom portion of the right controller 15. That is, in accordance with the bottom portion of the right controller 15 facing forward, the palm of the right hand 204 of the character similarly faces forward.

Thereafter, for example, as shown in FIG. 9(2), when a gyro operation of tilting the y-axis of the right controller 15 to the right is performed, the right hand 204 of the character is tilted to the right accordingly. As described above, by tilting the right controller 15, the right hand 204 of the character can be moved, thereby intuitively causing the character to perform actions such as waving a hand.

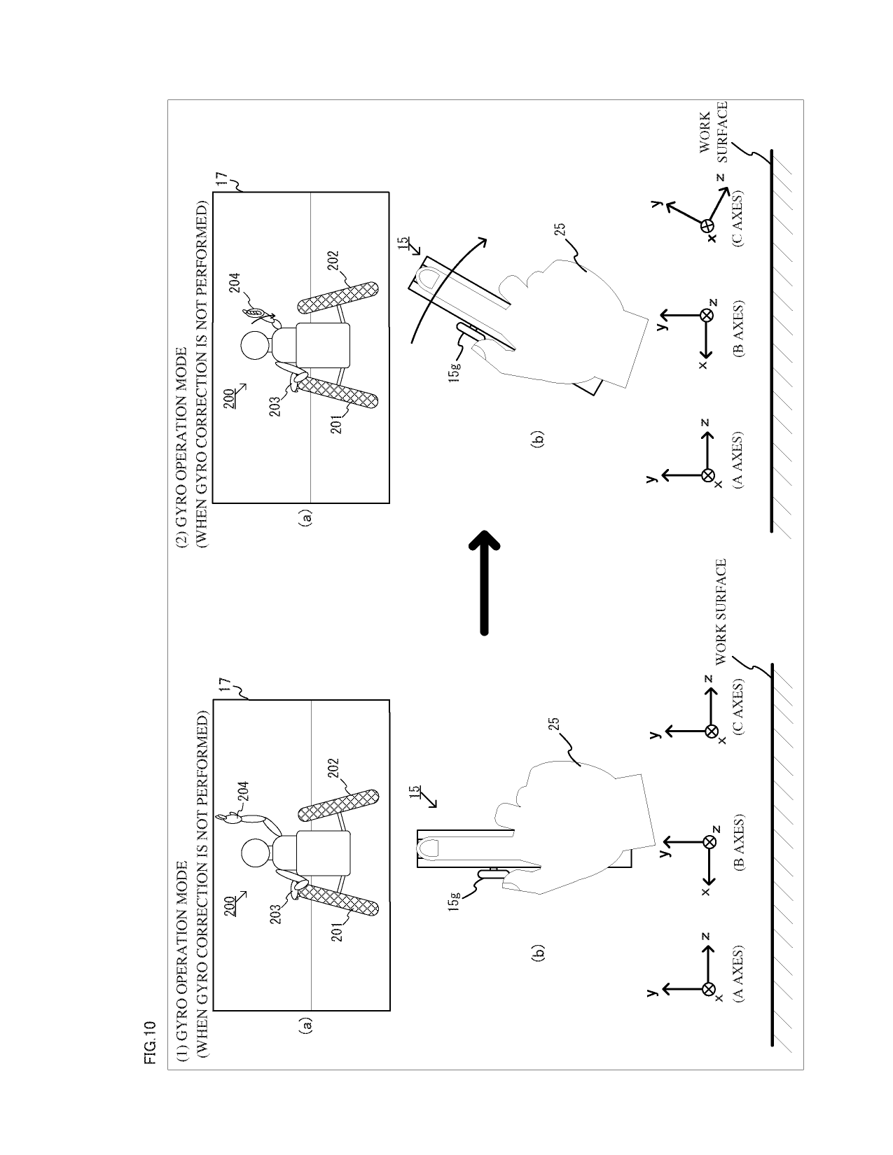

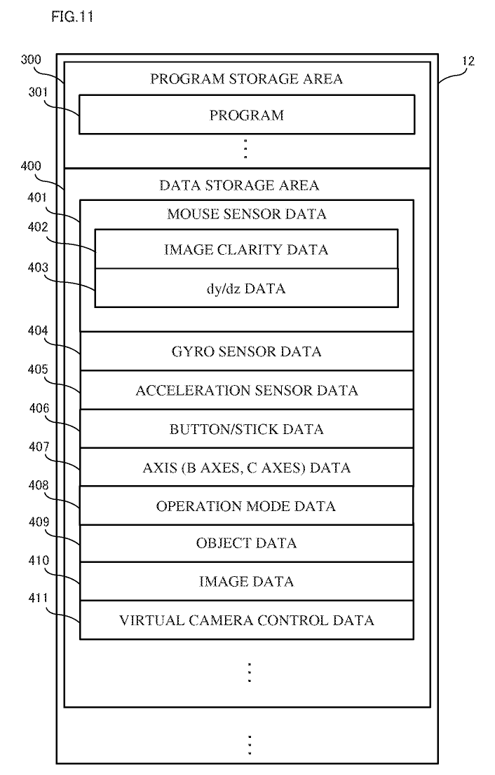

FIG. 10 illustrates a case in which, when the operation mode is shifted from the mouse operation mode to the gyro operation mode as shown in FIG. 8, etc., gyro correction is not performed and the direction around the y-axis of the B axes is not corrected. In this case, the processor 11 recognizes that the bottom portion of the right controller 15 is facing rightward. Therefore, as shown in FIG. 10(1), the palm of the right hand 204 of the character faces rightward. Further, as shown in FIG. 10(2), when a gyro operation of tilting the y-axis of the right controller 15 to the right as in FIG. 9(2) is performed, the right hand 204 of the character is tilted toward the near side.

### Information Processing of Exemplary Embodiment

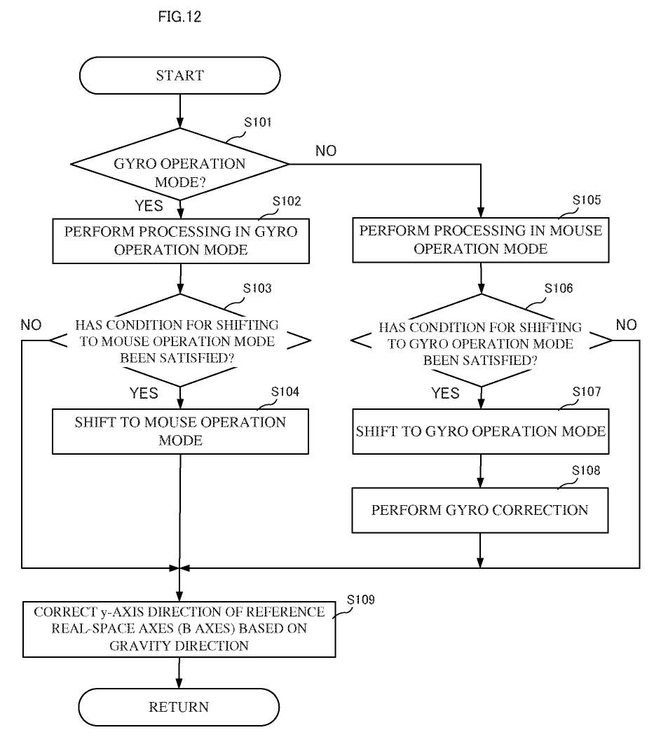

With reference to FIGS. 11 and 12, the information processing of the exemplary embodiment will be described.

### Data to Be Used

Various data stored in the storage section 12 will be described. FIG. 11 shows an example of data stored in the storage section 12 of the game apparatus 10. As shown in FIG. 11, the storage section 12 is provided with at least a program storage area 300 and a data storage area 400.

At least a program 301 is stored in the program storage area 300. At least mouse sensor data 401, gyro sensor data 404, acceleration sensor data 405, button/stick data 406, axis data 407, operation mode data 408, object data 409, image data 410, and virtual camera control data 411 are stored in the data storage area 400.

The program 301 is a game program for performing game processing.

The mouse sensor data 401 is data about outputs of the mouse sensor 15e and the mouse sensor 16e and includes image clarity data 402 and dy/dz data 403.

The image clarity data 402 is data calculated by the mouse sensor 15e and the mouse sensor 16e and indicates the clarity of a mouse sensor image. The image clarity data 402 may be calculated, for example, based on the degree of brightness of the mouse sensor image or the degree of how many feature points the mouse sensor image has. The image clarity data 402 may be calculated based on output data from the mouse sensor, by the processor included in the controller, or by the processor 11 or the like. The degree of brightness of the mouse sensor image or the degree of how many feature points the mouse sensor image has may be directly used as the image clarity data. The image clarity data 402 may be calculated based on another element. When the clarity indicated by the image clarity data 402 is equal to or greater than a specified value, the opening for the mouse sensor can be estimated to be blocked by the placement surface or the like. Instead of, or in addition to data indicating the clarity of the mouse sensor image, other data may be used as long as whether the opening for the mouse sensor is blocked can be estimated by the data.

The dy/dz data 403 is output data from the mouse sensor 15e and the mouse sensor 16e, and indicates a movement distance per frame time (which may be referred to as “dy/dz”) in the y-axis direction and the z-axis direction (i.e., yz plane; see FIG. 2(1) and (2)) in the controller coordinate system relative to the work surface or the like when the opening for the mouse sensor is blocked by the work surface or the like. The movement distance dy/dz may be calculated based on output data from the mouse sensor, by the processor included in the controller, or by the processor 11 or the like.

The gyro sensor data 404 is data outputted from the gyro sensors of the controllers 15 and 16, and is, for example, data that allows calculation of the angular velocities around the x-, y-, and z-axes in the controller coordinate system (see FIG. 2(1) and (2)). Using the gyro sensor data, the orientation or the like of the controller can be calculated, for example.

The acceleration sensor data 405 is data outputted from the acceleration sensors of the controllers 15 and 16, and is, for example, data that allows calculation of the acceleration in the x-, y-, and z-axis directions in the controller coordinate system (see FIG. 2(1) and (2)). Using the acceleration sensor data, movement of the controller and a gravity direction can be calculated.

In calculating the orientation or movement of the controller, at least one of the gyro sensor data 404 and the acceleration sensor data 405 may be used.

The button/stick data 406 is data indicating operation states of the button and the stick of the controller.

The axis data 407 is data indicating the orientations of the B axes and the C axes described with reference to FIG. 5, etc.

The operation mode data 408 is data indicating, for each of the right controller 15 and the left controller 16, which of the mouse operation mode and the gyro operation mode is set.

The object data 409 is data of virtual objects to be placed in the virtual space, and is data of virtual objects such as the aim sight 100, the cursor 250, an object 200, ground, and buildings, for example. The object data 409 includes information about the positions, the orientations, etc., of the virtual objects.

The image data 410 is image data of animation images, backgrounds, virtual effects, etc. The aim sight 100 and the cursor 250 may be images rather than objects.

The virtual camera control data 411 is data for controlling a virtual camera that is placed in the virtual space and takes an image of the virtual space.

In addition, various data to be used in rendering processing, etc., are stored in the storage section 12, as necessary.

### Detailed Information Processing Example

Next, processing according to the exemplary embodiment will be described with reference to a flowchart and the like. FIG. 12 is an example of a flowchart showing the processing according to the exemplary embodiment. In the following, processing of the first example and the second example will be described with reference to FIG. 12. In the second example, since the right controller 15 and the left controller 16 are used, the processing shown in FIG. 12 is performed for each controller. In the following, processing characteristic to the exemplary embodiment will be mainly described, and the description of other processing such as rendering processing is basically omitted. The processing may include other processing, or a part of the processing may be omitted. The following processing is repeatedly performed at specified intervals (e.g., frame intervals in processing performed per 1/60 seconds).

When the game processing is started, in step S101, the processor 11 determines whether or not the controller is in the gyro operation mode, based on the operation mode data 408. If the determination result in step S101 is YES, the processing proceeds to step S102, and if the determination result in step S101 is NO, the processing proceeds to step S105.

In step S102, the processor 11 performs processing in the gyro operation mode based on the gyro sensor data 404, etc. For example, in the first example, the position of the aim sight 100 is controlled in response to a gyro operation (see FIG. 5(1)), and a bullet is fired in a direction toward the aim sight 100 in response to a button press operation. For example, in the second example, movement of a hand of the character is controlled in response to a gyro operation (see FIG. 9). Then, the processing proceeds to step S103.

In step S103, the processor 11 determines whether or not a condition for shifting to the mouse operation mode has been satisfied. For example, in the first example and the second example, as described with reference to FIG. 5, when it is determined based on the mouse sensor data 401, the gyro sensor data 404, etc., that the bottom portion of the controller is blocked by the work surface or the like and that the longitudinal direction of the controller is substantially horizontal, it may be determined that the condition for shifting to the mouse operation mode has been satisfied. If the determination result in step S103 is YES, the processing proceeds to step S104, and if the determination result in step S103 is NO, the processing proceeds to step S109.

In step S104, the processor 11 shifts the operation mode of the controller to the mouse operation mode. Then, the processing proceeds to step S109.

In step S105, the processor 11 performs processing in the mouse operation mode based on the mouse sensor data 401, etc. For example, in the first example, the position of the cursor 250 is controlled in response to a mouse operation (see FIG. 5(2)). For example, in the second example, movement of the object 200 is controlled in response to a mouse operation (see FIG. 8(1)). Here, in the mouse operation mode, object control based on the gyro sensor data 404 is not performed, and no object is operated based on the gyro sensor data 404. Then, the processing proceeds to step S106.

In step S106, the processor 11 determines whether or not a condition for shifting to the gyro operation mode has been satisfied. For example, in the first example, as described with reference to FIG. 6, when it is determined based on the mouse sensor data 401 that the controller has been lifted from the work surface, it may be determined that the condition for shifting to the gyro operation mode has been satisfied. For example, when it is determined that the clarity of the mouse sensor image indicated by the image clarity data 402 is equal to or less than a specified value, it may be determined that the controller has been lifted from the work surface, and it may be determined that the condition for shifting to the gyro operation mode has been satisfied. Alternatively, for example, a distance sensor may be provided at the bottom portion of the controller, and, when it is determined that the distance to the work surface or the like is equal to or greater than a specified value, it may be determined that the controller has been lifted from the work surface, and it may be determined that the condition for shifting to the gyro operation mode has been satisfied. Alternatively, for example, a button may be provided at the bottom portion of the controller, it may be determined based on a pressed state of the button that the controller has been lifted from the work surface, and it may be determined that the condition for shifting to the gyro operation mode has been satisfied. For example, in the second example, as described with reference to FIG. 8(2), when it is determined based on the acceleration sensor data 405, the axis data 407, etc., that the y-axis direction of the C axes forms an angle of 30° with the horizontal plane, it may be determined that the condition for shifting to the gyro operation mode has been satisfied. Two or more of the above determination conditions may be combined, or other determination conditions may be used. If the determination result in step S106 is YES, the processing proceeds to step S107, and if the determination result in step S106 is NO, the processing proceeds to step S109.

In step S107, the processor 11 shifts the operation mode of the controller to the gyro operation mode. Then, the processing proceeds to step S108.

In step S108, the processor 11 performs gyro correction based on the axis data 407, as described with reference to FIG. 6(1) and FIG. 8(2). Then, the processing proceeds to step S109.

In step S109, the processor 11 corrects the y-axis positive direction of the reference real-space axes (B axes) based on a gravity direction calculated from the acceleration sensor data 405, such that the y-axis positive direction is opposite to the gravity direction. Then, the processing returns to step S101.

According to the above-described embodiment, when shifting from the mouse operation mode to the gyro operation mode in accordance with the state of the controller, gyro correction is performed without requiring, for example, a button operation or the like by the user (see FIGS. 6 and 8), thereby providing excellent usability. As an example, by performing gyro correction based on the orientation of the controller and also switching from the mouse operation mode to the gyro operation mode (see FIG. 8), an unintended shift to the gyro operation mode against the user’s intention, for example, when the user lifts the controller from the work surface in order to adjust the position of the controller during a mouse operation, is suppressed.

For example, in the second example, a mouse operation is assumed to be an operation in which the user reciprocally moves the controller forward and backward on the work surface. Therefore, it is assumed that the front portion of the controller, that is, the positive y-axis direction, is directed generally toward the screen. When the user lifts the controller in order to perform a gyro operation from a state where such a mouse operation is being performed, it is assumed that the controller is raised such that the y-axis of the controller is directed in a direction opposite to the gravity direction while maintaining the state of being directed toward the screen. Therefore, by performing gyro correction in the direction described in the second example, subsequent gyro operations can be performed with little discomfort to the user.

According to the above-described embodiment, in the mouse operation mode, object control based on changes in the orientation of the controller is not performed. Thus, in the mouse operation mode, the user can perform operations without being concerned about gyro drift.

According to the above-described embodiment, the object to be operated in the mouse operation mode and the object to be operated in the gyro operation mode are different objects (see FIG. 5, FIG. 8(1), and FIG. 9(1)). Thus, while suppressing discomfort to the user caused by performing gyro correction (for example, discomfort caused by instantaneous changes in the position, the orientation, or the like of the object), it is possible to start operation of the object to be operated in the gyro operation mode.

According to the above-described embodiment, the condition for performing gyro correction (see FIG. 6(1) and FIG. 8(2)) does not include a condition related to the inclination of the z-axis direction of the controller. Thus, for example, when a mouse operation is performed using a cylindrical curved surface such as a user’s thigh as a work surface, it is possible to avoid an unintended shift to the gyro operation mode against the user’s intention.

### Modifications

In the mouse operation mode as well, objects (for example, the cursor 250, the object 200, other objects, etc.) may be controlled using the gyro sensor data (see FIG. 11).

The object to be operated in the mouse operation mode and the object to be operated in the gyro operation mode may be the same.

Gyro correction and shift to the gyro operation mode may be performed based on the inclination of the z-axis of the controller with respect to the horizontal plane.

Gyro correction may be performed before switching to the gyro operation mode. Gyro correction is not limited to being performed only once when switching from the mouse operation mode to the gyro operation mode, and may be performed, for example, constantly or periodically during the mouse operation mode. Thus, when shifting from the mouse operation mode to the gyro operation mode, gyro drift is appropriately corrected by the gyro correction performed last. Even in such a case, since gyro correction is finalized in conjunction with switching to the gyro operation mode, it can be said that gyro correction is performed when the condition for switching to the gyro operation mode is satisfied.

Further, in addition to operations for performing gyro correction as described in the above embodiment (see FIGS. 6 and 8(2)), gyro correction may be performed in response to a specified operation (for example, an operation of pressing the button 15f).

Further, the object to be operated in the gyro operation mode may be switched in response to a specified operation (for example, an operation of pressing the button 15f, a specified change in the orientation of the controller, or the like). For example, in the second example, control may be switched from control that allows movement of a hand of the character by a gyro operation (see FIG. 9(2)) to control in which a menu image is displayed in response to a specified operation and a cursor displayed on the menu image can be moved by a gyro operation. For example, in the second example, control may be switched from control that allows change of the orientation or the like of the character by a gyro operation to control in which an aim sight for causing the character to perform shooting is displayed in response to a specified operation and the aim sight can be moved by a gyro operation. In this case, gyro correction may not necessarily be performed.

Which axis of the reference real-space axes is corrected to which orientation when gyro correction is performed is not limited. The manner of correction may differ depending on a game, or may differ depending on a game situation even within the same game. For example, it is assumed that, with respect to control of an object operated by a gyro operation, an appropriate manner of holding the controller differs between a first mode and a second mode. As an example, in the first mode, the controller is assumed to be held in a manner shown in FIG. 9(1), whereas in the second mode, the controller is assumed to be held with both hands such that the longitudinal direction of the controller is directed sideways and the bottom portion of the controller faces upward or forward. In such a case, a correction method to be applied when gyro correction is performed may be determined according to whether an object operated in the gyro operation mode after shift from the mouse operation mode is in the first mode or the second mode. In this case, the condition for performing gyro correction and/or the condition for switching the operation mode may also be determined according to whether the object after switching the operation mode is in the first mode or the second mode.

Further, in the above-described embodiment, at least a part of the processing performed by the processor 11 may be performed by the processors (15a, 16a) of the controllers.

The game apparatus 10 is merely an example of the information processing apparatus, and the information processing apparatus may be an apparatus that does not execute a game. Similarly, the information processing system may be a system that does not execute a game. The type of the program is not limited, and the game program is merely an example. The program may be, for example, a drafting program, a content viewing program, or a menu program.

The shape of each controller is merely an example, and may be, for example, another shape. In the game apparatus 10, only one controller or three or more controllers may be used. Further, the controller may not necessarily have some of the operation sections, or may have other operation sections.

The various data in the above-described embodiment are merely examples. In each processing, even when data is converted into other data, the converted data may be regarded as substantially the same data.

The information processing system may include a terminal-side apparatus and a server-side apparatus which can communicate with each other via a network, and at least a part of the series of processes described above may be executed by the server-side apparatus. The server may be composed of a plurality of information processing apparatuses, and the processing may be executed in a shared manner by the plurality of information processing apparatuses.

While the exemplary embodiment and modifications have been described above, it is to be understood that the above description is, in all aspects, merely an illustrative example, and is not intended to limit the scope thereof. In addition, it is to be understood that various improvements and changes can be made to the exemplary embodiment and modifications.

What is claimed is:

1. One or more non-transitory computer-readable storage media having stored therein instructions that, when executed, cause one or more processors to perform operations comprising:
in a first operation mode, operating a first object based on mouse sensor data outputted from a mouse sensor of an input device;
in a second operation mode, operating a second object based on gyro sensor data outputted from a gyro sensor of the input device; and
based on a first condition being satisfied, shifting from the first operation mode to the second operation mode and performing gyro correction for a direction perpendicular to a gravity direction.

2. The one or more non-transitory computer-readable storage media according to claim 1, wherein the gyro correction comprises setting, as a front direction, a direction of a component in a longitudinal direction of the input device, the component being perpendicular to the gravity direction.

3. The one or more non-transitory computer-readable storage media according to claim 1, wherein the operations further comprise acquiring the mouse sensor data and the gyro sensor data, and in the first operation mode, operating the first object based on the acquired mouse sensor data.

4. The one or more non-transitory computer-readable storage media according to claim 1, wherein the first object and the second object are different objects.

5. The one or more non-transitory computer-readable storage media according to claim 1, wherein
a light-receiving opening for the mouse sensor is provided in a bottom surface of the input device, and
the first condition includes a condition that is satisfied when the light‑receiving opening is not blocked.

6. The one or more non-transitory computer-readable storage media according to claim 1, wherein
a light-receiving opening for the mouse sensor is provided in a bottom surface of the input device, and
the first condition includes a condition that a longitudinal axis of the input device that is parallel to the bottom surface and extends from a near side to a far side when the input device is held by a user is inclined by a specified angle or more with respect to a direction perpendicular to the gravity direction.

7. The one or more non-transitory computer-readable storage media according to claim 6, wherein the first condition does not include a condition regarding inclination, with respect to a direction perpendicular to the gravity direction, of a short axis of the input device that is parallel to the bottom surface and is perpendicular to the longitudinal axis.

8. The one or more non-transitory computer-readable storage media according to claim 1, wherein
a light-receiving opening for the mouse sensor is provided in a bottom surface of the input device, and
the first condition includes a condition indicating that a bottom surface of the input device is separated from a work surface.

9. The one or more non-transitory computer-readable storage media according to claim 1, wherein the operations further comprise controlling the second object based on a movement in a rotational direction around a longitudinal axis directed in a longitudinal direction of the input device.

10. An information processing system comprising one or more processors and one or more non-transitory computer-readable storage media having stored therein instructions that, when executed, cause the one or more processors to perform operations comprising:
in a first operation mode, operating a first object based on mouse sensor data outputted from a mouse sensor of an input device;
in a second operation mode, operating a second object based on gyro sensor data outputted from a gyro sensor of the input device; and
based on a first condition being satisfied, shifting from the first operation mode to the second operation mode and performing gyro correction for a direction perpendicular to a gravity direction.

11. The information processing system according to claim 10, wherein the first object and the second object are different objects.

12. The information processing system according to claim 10, wherein
a light-receiving opening for the mouse sensor is provided in a bottom surface of the input device, and
the first condition includes a condition that a longitudinal axis of the input device that is parallel to the bottom surface and extends from a near side to a far side when the input device is held by a user is inclined by a specified angle or more with respect to a direction perpendicular to the gravity direction.

13. The information processing system according to claim 12, wherein the first condition does not include a condition regarding inclination, with respect to a direction perpendicular to the gravity direction, of a short axis of the input device that is parallel to the bottom surface and is perpendicular to the longitudinal axis.

14. The information processing system according to claim 10, wherein
a light-receiving opening for the mouse sensor is provided in a bottom surface of the input device, and
the first condition includes a condition indicating that a bottom surface of the input device is separated from a work surface.

15. A computer-implemented method comprising:
in a first operation mode, operating a first object based on mouse sensor data outputted from a mouse sensor of an input device;
in a second operation mode, operating a second object based on gyro sensor data outputted from a gyro sensor of the input device; and
based on a first condition being satisfied, shifting from the first operation mode to the second operation mode and performing gyro correction for a direction perpendicular to a gravity direction.

16. The computer-implemented method according to claim 15, wherein the first object and the second object are different objects.

17. The computer-implemented method according to claim 15, wherein
a light-receiving opening for the mouse sensor is provided in a bottom surface of the input device, and
the first condition includes a condition that a longitudinal axis of the input device that is parallel to the bottom surface and extends from a near side to a far side when the input device is held by a user is inclined by a specified angle or more with respect to a direction perpendicular to the gravity direction.

18. The computer-implemented method according to claim 17, wherein the first condition does not include a condition regarding inclination, with respect to a direction perpendicular to the gravity direction, of a short axis of the input device that is parallel to the bottom surface and is perpendicular to the longitudinal axis.

19. The computer-implemented method according to claim 15, wherein
a light-receiving opening for the mouse sensor is provided in a bottom surface of the input device, and
the first condition includes a condition indicating that a bottom surface of the input device is separated from a work surface.
